(19) United States
(12) Patent Application Publication
(10) Pub. No.: US 2013/0333334 A1
(43) Pub. Date: Dec. 19, 2013

(54) EMULSION DISINFECTING, SANITIZING, AND CLEANING COMPOSITIONS MADE WITH HYDROPHOBIC ANTIMICROBIAL AGENTS

(71) Applicant: EnviroSystems, Inc., Mooresville, NC (US)

(72) Inventors: Paul S. Malchesky, Painesville, OH (US); J. Lloyd Breedlove, Statesville, NC (US); George E. Grignol, Fairview, PA (US)

(21) Appl. No.: 13/970,704

(22) Filed: Aug. 20, 2013

Related U.S. Application Data
(63) Continuation-in-part of application No. 13/555,799, filed on Jul. 23, 2012.
(60) Provisional application No. 61/512,017, filed on Jul. 27, 2011.

(51) Int. Cl. A01N 25/04

(52) U.S. Cl. CPC A01N 25/04
USPC 53/474; 514/737; 424/405

(57) ABSTRACT

Antimicrobial emulsions having hydrophobic antimicrobial agents, surfactants, solubilizing agents, metal chelators and optionally thickening agents. The emulsions have a small particle size and high zeta potential. The emulsions are effective in cleaning, sanitizing, and disinfecting surfaces and are effective in killing a variety of organisms. The emulsions are stable and have a long shelf life.

### CROSS REFERENCE TO RELATED APPLICATION

This application is a continuation-in-part of U.S. patent application Ser. No. 13/555,799 filed on Jul. 23, 2012 which claims priority from U.S. Provisional Application No. 61/512,017 filed on Jul. 27, 2011.

### TECHNICAL FIELD

The present invention relates to compositions containing hydrophobic or low water soluble antimicrobial agents in aqueous solutions that may be applied as a liquid, including in a spray, a wipe or gel and other forms. The compositions are used to disinfect, sanitize, and clean inanimate surfaces.

### BACKGROUND

Aqueous solutions are used as disinfectants, sanitizers, and cleaning agents for the control, removal, kill, and inactivation of microorganisms on inanimate surfaces to prevent their contamination of the surfaces and those that come in contact with these surfaces.

Various solutions as disinfectants, sanitizers, and cleaning agents are prior art available that carry antimicrobial claims and most utilize water soluble chemistries. Low solubility or non-water soluble, hydrophobic antimicrobials are lipid-like in nature and permit interactions with the hydrophobic structures of microorganisms and thereby inactivating them. These hydrophobic antimicrobials are typically not employed because of the difficulties in solubilizing them and preparing stable liquid formulations. Some past work with hydrophobic antimicrobial agents produce initially high particle sizes in the aqueous emulsion. These large particle sizes increase in size in shelf storage. These hydrophobic agents, when used to create an emulsion, the emulsion must be homogenized with significant mechanical force to create smaller particle size in the emulsion. Even with homogenization, the particles have a low zeta potential which results in an emulsion that is not very stable.

There is a long felt need for an emulsion which uses hydrophobic antimicrobial agents in an aqueous medium that has small particle size and high zeta potentials without the need for homogenization.

There is also an increasing awareness and concern that common household type disinfecting, sanitizing, and cleaning agents can have short term and long term toxic concerns and can be associated with adverse health effects. Further there are concerns for many of the agents that they may accumulate and have an adverse impact on the environment. Therefore, there is a need for disinfecting, sanitizing, and cleaning agents based on natural, biodegradable, and sustainable ingredients such as essential oils and naturally derived surfactants/solubilizing agents which would be good for the user and the environment, while not sacrificing efficacy.

### SUMMARY

It is an object of this invention to provide an antimicrobial emulsion composition in an aqueous base which is useful for disinfecting, sanitizing, and cleaning surfaces.

It is a further object of the invention to use a hydrophobic antimicrobial agent in the antimicrobial emulsion composition.

It is another object to provide a ready-to-use antimicrobial composition that is safe for personnel using the composition and is environmentally friendly.

It is a further object to provide an antimicrobial composition that is shelf stable and does not require homogenization in its manufacture.

It is also an object that the ingredients used to make the antimicrobial composition are noncorrosive to the equipment used to manufacture the composition.

It is a further object that the antimicrobial emulsion particles have a small particle size and high zeta potential which leads to excellent shelf stability and does not require homogenization in the manufacture of the emulsion composition.

The above objects are accomplished by an embodiment of an antimicrobial emulsion formulation comprising:

(a) water;

(b) at least one hydrophobic antimicrobial agent selected from the group consisting of (i) a halogen substituted xylenol compound, (ii) a phenolic compound, (iii) an antimicrobial natural or essential oil, (iv) an antimicrobial component from natural or essential oil, and (v) combinations of at least two of (i), (ii), (iii) and (iv);

(c) at least one surfactant, wherein said surfactant is selected from the group consisting of anionic surfactant, amphoteric surfactant, nonionic surfactant, and blends thereof:

(d) at least one solubilizing agent;

(e) optionally, at least one metal chelator; and

(f) optionally, said antimicrobial emulsion formulation may also comprise ingredients selected from the group consisting of pH adjusters, thickening agents, and colorants.

The emulsion can be used as a ready-to-use spray or wipe or can be thickened to a gel form for more concentrated use.

The terms antimicrobial composition and antimicrobial formulation are used interchangeably herein.

In a preferred embodiment, the antimicrobial agent in the antimicrobial emulsion composition is parachlorometaxylenol (CAS No. 88-04-0).

In another preferred embodiment, the surfactant in the antimicrobial emulsion composition is selected from the group consisting of alkyl sulfate, alkyl ether sulfate, potassium ricinoleate, alkylglucoside, and mixtures thereof.

In another preferred embodiment the solubilizing agent in the antimicrobial emulsion composition is selected from the group consisting of low molecular weight alcohols having from 2 to 10 carbon atoms, glycols, terpineols, phenoxetol, and mixtures thereof.

In another preferred embodiment the metal chelator in the antimicrobial emulsion composition is selected from the group consisting of trisodium ethylene diamine tetraacetic acid, sodium polyphosphate, and mixtures thereof.

The most preferred water is deionized water.

Excellent results have been obtained with an antimicrobial emulsion composition having

(a) from about 97.78 to about 98.87 weight percent deionized water;

(b) from about 0.2 to about 0.24 weight percent parachlorometaxylenol;

(c) from about 0.2 to about 0.4 weight percent potassium ricinoleate;

(d) from about 0.06 to about 0.1 weight percent sodium dodecyl sulfate;

(e) from about 0.2 to about 0.4 weight percent terpineol;

(f) from about 0.03 to about 0.1 weight percent sodium polyphosphate;

(g) from about 0.3 to about 0.6 weight percent isopropyl alcohol;

(h) from about 0.04 to about 0.08 weight percent phenoxetol; and

(i) from about 0.1 to about 0.3 weight percent trisodium ethylene diamine tetraacetic acid.

### DETAILED DESCRIPTION OF EXEMPLARY EMBODIMENTS

Exemplary embodiments in accordance with the present invention will be described. Various modifications, adaptations or variations of the exemplary embodiments described herein may become apparent to those skilled in the art as such are disclosed. It will be understood that all such modifications, adaptations or variations that rely upon the teachings of the present invention, and through which these teachings have advanced the art, are considered to be within the scope and spirit of the present invention.

The methods and compositions of the present invention may suitably comprise, consist of, or consist essentially of the components, ingredients, elements, steps and process delineations described herein. The invention illustratively disclosed herein suitably may be practiced in the absence of any element, process step, or ingredient which is not specifically disclosed herein.

Unless otherwise stated, all percentages, parts, and ratios expressed herein are based upon weight of the total compositions of the present invention.

The term “home care products” as used herein includes, without being limited thereto, products employed in a domestic household for surface cleaning or maintaining sanitary conditions, such as in the kitchen and bathroom or any other inanimate surfaces that are in need of being sanitized.

The term “institutional and industrial care” as used herein includes, without being limited thereto, products employed for surface cleaning or maintaining sanitary conditions in schools, hospitals, nursing homes, restaurants, public transportation, industrial facilities, and offices.

The headings provided herein serve to illustrate, but not to limit the invention in any way or manner.

### Antimicrobial Agent

The first necessary ingredient of the antimicrobial emulsion formulation of this invention is the antimicrobial agent. In one embodiment the antimicrobial agent is a halogen substituted xylenol, with the preferred antimicrobial agent being parachlorometaxylenol (hereinafter referred to as PCMX). PCMX is also known as 4-chloro-3,5-dimethyl-hydroxy benzene, 4-cholor 3,5-dimethyl phenol, 4-chloro 3,5 xylenol, and 4-chloro meta xylenol. PCMX is a chlorine substituted xylenol with a molecular formula of C₈H₉ClO and has a molecular weight of 156.5 with a CAS No. 88-04-0. PCMX's mechanism of antimicrobial action is by the denaturation of proteins and inactivation of enzymes in the microorganisms. Also likely, this agent, as for other phenolic compounds, alters the permeability of the cell membrane that could result in the uncoupling of oxidative phosphorylation, inhibition of active transport, and loss of pool metabolites due to cytoplasmic membrane damage. Compared to phenols, xylenols exhibit increased antimicrobial activity, on the order of from 30 to 60 times more. The chlorine substitution intensifies the antimicrobial potency.

Other antimicrobial agents which may be used include phenols and substituted phenols, triclosan, trichlocarban, other phenolics such as para tertiary amylphenol (PTAP), o-benzyl-p-chlorophenol (BCP), and ortho-phenyl-phenol (OPP). Other antimicrobial agents include benzalkonium chloride, benzethonium chloride, biguanide, and chlorohexidine gluconate.

As mentioned above, the halogen substituted xylenol (PCMX) is the preferred antimicrobial agent, because it is very effective and environmentally friendly. However, one or more antimicrobial agent may be used in combination with another antimicrobial agent.

In another embodiment, the antimicrobial agent is an antimicrobial natural or essential oil, which can be a natural or synthetic version, or components from such oils that are known to be antimicrobial. Natural or essential oils include terpineol, thyme, wild thyme, red thyme, thyme white, thymol, origanum, oregano and a main constituent carvacrol, lemongrass, lemon, orange, lime, lavender and its constituents lavandin and lavandula, tea tree and its constituents including terpinen-4-ol, wintergreen, eucalyptus and its components as 1,8-cineol and eucalyptol, menthol, cornmint, laurel, ziziphora, bay, sweet orange, cinnamon, cinnamon bark, rose, rosewood, clove, peppermint, rose geranium, geranium, meadowsweet, anise, orris, mustard, rosemary, cumin, neroli, birch, Melissa balm, ylang ylang, juniper, sweet fennel, garlic, cajeput, sassafras, heliotrope, pine, pine oils and their derivatives and components, parsley, violet, coriander, citron, citronella, patchouli, bergamot, sandalwood, eugenol, verbenone, geraniol, limonene, fennel, sesame, geraniol, hinokithiol, citral, terpinene, citronellal, citronellol, linalool, anethole, inenthone, carvone, camphor, and mixtures and components from such.

### Surfactant

The antimicrobial formulation also contains as a necessary ingredient at least one surfactant. In one embodiment the surfactant is selected from the group consisting of anionic surfactant, amphoteric surfactant, nonionic surfactant, and blends thereof. Anionic surfactants include alkyl sulfates such as sodium lauryl sulfate, sodium laureth (sodium lauryl ether sulfate—SLES) sulfate; ammonium lauryl or laureth sulfate, TEA lauryl or laureth sulfate, MEA lauryl or laureth sulfate, potassium lauryl or laureth sulfate, sodium dodecyl sulfate (SDS), sodium octyl/decyl sulfate, sodium 2-ethyl-hexyl sulfate, sodium octyl sulfate, alkyl ethoxylates, alkyl ethoxylate sulfates, alkyl aryl sulfates, alkyl aryl sulfonates, fatty acid soaps, natural acids saponified such as ricinoleate, alkylsulfonic acid salts, fatty alcohol sulfates, sodium xylene sulphonate, ammonium xylene sulphonate, sodium toluene sulphonate, sodium cumeme sulfate and other hydrotropes, alkyl phosphates as lauryl phosphate, sulfosuccinates as disodium lauryl and laureth sulfosuccinates, alphaolefin sulphonate, and alkyl phenol ether sulfate. Anionic surfactants such as derived from natural sources or recognized as GRAS (Generally Recognized As Safe) that are environmentally friendly are preferred.

Suitable amphoteric surfactants includes the general class of alkyl betaines as laurylamidopropyl betaine, oleyl betaine, ether amine oxides as lauryl dimethyl amine oxide, cocoamidopropyl dimethyl amine oxide and phospholipids composed of diester and triester phosphatides. Amphoteric surfactants such as derived from natural sources or recognized as GRAS that are environmentally friendly are preferred.

Suitable nonionic surfactants includes various liner or non-phenol alcohols or fatty acids, ethers of fatty alcohols, octylphenoxy polyethoxyethanol, ethoxylated alcohols, ethoxylated amines, ether amines and ether diamines as cocoamid DEA, cocoamide MEA, esters as ethylene glycol monostearate, ethylene glycol distearate as polyoxyethylene sorbitan esters, polysorbates, linear ethylene oxide/propylene oxide and/or butylenes oxide block copolymers, poly(5) oxyethylene isodecyloxypropylamine, poly (5) oxyethylene isotridecyloxypropylamine, glycols, and amine oxides as long chain alkyls. Preferred nonionic surfactants include polysorbates as Tween 20, 40, or 80, Igepal, Tritons, and glucosides as decyl glucoside, lauryl glucosides, D-glucopyranoside C10 to C16 alkyl oligomer and D-glucopyranoside C6 to C12 alkyl oligomer. These preferred nonionic surfactants readily biodegrade, are environmentally friendly and are gentle.

### Solubilizing Agent

The antimicrobial formulation of this invention also contains as a necessary ingredient at least one solubilizing agent. The solubilizing agent is necessary because many antimicrobials, such as PCMX, are not soluble or very slightly soluble in water. The combination of the surfactant and solubilizing agent allows a stable emulsion to be made.

Suitable solubilizing agents include low molecular weight alcohols such as ethanol, propanol, isopropanol, glycols such as propylene glycol and polypropylene glycols. Ethanol, isopropyl alcohol, and propylene glycol are among the preferred solubilizing agents. Other preferred solubilizing agents include the cyclic terpenes such as pine oils and their components as the monoterpene alcohols, terpineols, or pine oil derivatives and their isomers alpha, beta and gamma. Note that some ingredients can serve more than one function, such as terpineol which serves as an antimicrobial agent and as a solubilizing agent for the hydrophobic antimicrobial agent.

### Water

Another necessary ingredient of the antimicrobial emulsion formulation is water. In making the ready to use antimicrobial emulsion formulation suitable for later use, deionized water is highly recommended to provide consistent quality. Although city tap water could be used, deionized water is highly preferred.

### Metal Chelators

Various chemical agents are available to chelate or sequester metal ions in water. They are typically organic molecules and are employed to soften water in formulations. Some examples of metal chelators include organic acids, such as citric acid, sodium and potassium salts of ethylene diaminetetraacetic acid and nitrilotriacetic acid, sodium and potassium salts of methyl glycine diacetic acid, and bisphosphonates. Metal chelators can be important because some of the ingredients, particularly surfactants, can contain metal ions. Also, if water other than deionized water is used, a metal chelator may be necessary.

### pH Adjusters

The antimicrobial emulsion of this invention has a pH range of from 6 to 9, preferably from 7 to 8.8, and more preferred from about 7.5 to about 8.5. The pH of the antimicrobial emulsion can be adjusted, if necessary, by using mineral acids, mineral bases, organic acids, and amines. The preferred pH adjusters are hydrochloric acid and citric acid. In some formulations, the pH will be in the desired range and will not need to be adjusted. The pH should be tested and adjusted, if necessary to achieve the desired range mentioned above.

### Thickeners

In some applications it may be desired to provide the antimicrobial emulsion in a thickened or gel form. To thicken the emulsion thickening agents such as sodium chloride, acrylic polymers, carbomers, polysaccharides as starches and vegetable gums, proteins, and polyethylene glycol may be used to achieve the desired thickened emulsion.

Another important advantage of the antimicrobial emulsion of this invention is the stability of the emulsion without the need for homogenization. To enhance stability of the emulsion it is necessary to have a small particle size and a large zeta potential in the emulsion.

The emulsion of this invention has a particle size of less than 300 nm, preferably less than 100 nm and more preferably from about 60 nm to about 80 nm

A high zeta potential is also important for stability of the emulsion. Zeta potential is a measure of the potential difference between the dispersion phase (water) and the stationary layer of fluid attached to the dispersed particle and represents the degree of repulsion between adjacent, similarly charged particles. A high zeta potential will confer stability, i.e. the dispersion will resist aggregation. A zeta potential of about 25-30 mV (positive or negative) is considered a value that separates low-charged surfaces from highly-charged surfaces. The zeta potential value can be positive or negative. The important point is the number value. That is a zeta potential of −100 mv is greater than −30 mv and thus is preferred. The zeta potential of the emulsion in this invention is negative and a higher number, either positive or negative is considered better for stability. The emulsion of this invention will have a zeta potential greater than −30 mV, preferably greater than −60 mV, and more preferably greater than −90 mV. Excellent stability results have been obtained with zeta potentials in the range of from −90 mV to −105 mV.

The particle size and the zeta potential can be measured on a Malvern Instruments of Southborough, Mass. Zetasizer Nano-ZS instrument.

The absence of the need to homogenize the emulsion results in a more simplified manufacturing process and gives a cost saving.

The process to manufacture the ready-to-use antimicrobial emulsion of this invention involves adding the various ingredients (antimicrobial agent, surfactant, solubilizing agent, and if necessary, metal chelator) to water and gently stirring the mixture to create the emulsion. It is preferred that once the emulsion is formed it is filtered with a submicron filter prior to packaging. It is known that raw material chemistries can become contaminated with spore formers and other contaminates that can be picked up in the formulation during manufacturing. Filtration is a manufacturing step that is easy to perform on the ready-to-use emulsion prior to packaging that eliminates spore formers and other contaminants and allows for an aseptic fill. The filtration step provides for a higher quality, more consistent, and robust product. The emulsion can be packaged in any suitable container for later use. Suitable containers include but are not limited to glass or plastic containers such as high density polyethylene (HDPE) and preferably such containers have a spray mechanism to facilitate applying the emulsion to surfaces.

The levels of the various ingredients used to make the preferred novel antimicrobial emulsions of this invention is as follows:

(a) from about 0.18 to about 0.28 weight percent of antimicrobial agent, more preferably from about 0.2 to about 0.24 weight percent, with the preferred antimicrobial agent being parachlorometaxylenol (CAS No. 88-04-0);

(b) from about 0.1 weight percent to about 0.8 weight percent of surfactant, more preferably from about 0.25 to about 0.45 weight percent, with the preferred surfactant being a blend of potassium ricinoleate (CAS No. 7492-30-0) and sodium dodecyl sulfate (CAS No. 151-21-3);

(c) from about 0.2 weight percent to about 1.0 weight percent of solubilizing agent, more preferably from about 0.65 to about 0.85 weight percent, with the preferred solubilizing agent being a blend of alpha terpineol (CAS No. 98-55-5), isopropyl alcohol (CAS No. 67-63-0), and phenoxetol (CAS No. 122-99-6);

(d) from about 0.1 weight percent to about 0.8 weight percent of metal chelator, more preferably from about 0.15 to about 0.40 weight percent, with the preferred metal chelator being a blend of sodium polyphosphate (CAS No. 50813-16-6 or 10124-56-8) and trisodium ethylene diamine tetraacetic acid (trisodium EDTA) (CAS No. 150-38-9);

(e) the remainder of the emulsion is water, more preferably deionized water (CAS No. 7732-18-5), water will usually be present from about 97.78 weight percent to about 98.87 weight percent.

An optimized formulation for the antimicrobial emulsion is shown below.

| Ingredient | level (wt. %) |
|---|---|
| parachlorometaxylenol | 0.22% |
| potassium ricinoleate | 0.30% |
| sodium dodecyl sulfate | 0.08% |
| sodium polyphosphate | 0.05% |
| alpha terpineol | 0.27% |
| isopropyl alcohol | 0.44% |
| phenoxetol | 0.06% |
| trisodium EDTA | 0.20% |
| deionized water | 98.38% |

A prior art formulation for an antimicrobial emulsion is shown below.

| Ingredient | level (wt. %) |
|---|---|
| parachlorometaxylenol | 0.20% |
| potassium ricinoleate | 0.24% |
| alpha terpineol | 0.40% |
| isopropyl alcohol | 0.40% |
| deionized water | 98.76% |

Both the optimized formulation and the prior art formulation shown above were effective as antimicrobial agents. The prior art formulation had to be homogenized and still had a particle size of 400-600 nm (even higher if not homogenized). The zeta potential of the prior art formulation with homogenization was less than about −20 mV. In contrast the optimized formulation of this invention shown above, which was not homogenized, had a particle size of about 76 nm and a zeta potential greater than about −90 mV.

The above data shows that the emulsion of this invention is a much superior emulsion with higher stability and thus longer shelf life. This results from the smaller particle size and higher zeta potential of the emulsion of this invention.

Both the prior art formulation and the formulation of this invention were effective (kill) against a broad group of organism as shown below.

### Organism

### Bacteria

Staphylococcus aureus
Pseudomonas aeruginosa
Salmonella enteric (cholerasuis)
Methicillin resistant Staphylococcus aureus (MRSA)
Vancomycin resistant Enterococcus faecium (VRE)
Campylobacter jejuni
Escherichia coli
Escherichia coli OH157:H7
Listeria monocytogenes
Legionella pneumophilia
Streptococcus pyrogenes

### Mycobacterium

Mycobacterium bovis
Candida albicans
Trychophyton mentagrophytes

### Fungi

Trychophyton mentagrophytes
Candida albicans

### Viruses

Avian influenza A

### Cytomegalovirus

Herpes simplex virus (type 1 or type 2)
Human Hepatitis B (duck HBV as surrogate)
Human hepatitis C (bovine viral diarrhea virus as surrogate)
Human immunodeficiency virus type 1

### Influenza A2

Rhinovirus type 39
Human coronavirus
Canine parvovirus type-2

The following additional examples are presented to better illustrate the invention. Particle size and zeta potential were measured using a Melvern Zetasizer. The stability was also evaluated using a salt test. Salt is known to be effective for destabilizing (breaking an oil in water emulsion) an emulsion. The salt test involves using 25 ml of saturated salt water (sodium chloride). The salt water was added to a glass beaker and gently mixed with a magnetic stirrer. One ml of the antimicrobial emulsion was then added to the beaker containing the salt water. Observations were then made as a function of time. If formulations were not as stable an oily film/droplets will separate out and float. If formulations were more stable either no separation occurred or occurred over much longer time. In the examples, several formulations were compared for stability with the prior art formulation shown above. When the term “prior art formulation” is mentioned, it means the formulation shown above as the prior art formulation, which is believed to be the closest prior art.

The examples presented below are not intended to be limiting but rather to better show the importance of the various ingredients in the formulation.

### EXAMPLES

### Example 1

A composition was made with 0.3% potassium ricinoleate, 0.4% isopropyl alcohol, 0.4% terpineol, and 0.2% PCMX with the remainder deionized water. The solution was made by gentle mixing. The pH was adjusted with concentrated hydrochloric acid (HCl) to pH 8.60. The particle size was determined using a Malvern Zetasizer and determined to be 406 nm. By using a salt test this formulation compared well with the prior art formulation.

### Example 2

A composition was made with 0.3% potassium ricinoleate, 0.06% sodium dodecyl sulfate (SDS), 0.4% isopropyl alcohol, 0.4% terpineol, and 0.2% PCMX with the remainder deionized water. The solution was not homogenized. The pH was adjusted with concentrated hydrochloric acid (HCl) to pH 8.6. The particle size was determined using a Malvern Zetasizer and determined to be 475 nm. By using a salt test this formulation showed less separation vs the prior art formulation and suggested that the use of the additional surfactant improved the stability of the formulation.

### Example 3

A composition was made with 0.3% potassium ricinoleate, 0.2% isopropyl alcohol, 0.2% phenoxetol, 0.4% terpineol, and 0.2% PCMX with the remainder deionized water. The solution was mixed gently by inversion. The pH was adjusted with concentrated hydrochloric acid (HCl) to pH 8.6. The particle size was determined using a Malvern Zetasizer and determined to be 311 nm. With homogenization the particle size was 133 nm. By using a salt test this formulation showed less separation vs the prior art formulation and suggested that the use of the second alcohol improved the stability of the formulation.

### Example 4

A composition was made with 0.3% potassium ricinoleate, 0.3% isopropyl alcohol, 0.1% phenoxetol, 0.4% terpineol, and 0.2% PCMX with the remainder deionized water. The solution was mixed gently by inversion. The pH was adjusted with concentrated hydrochloric acid (HCl) to pH 8.4. The particle size was determined using a Malvern Zetasizer and determined to be 219 nm and was 152 after homogenization. By using a salt test this formulation showed less separation vs the prior art formulation and suggested that the reduction of the phenoxetol did not reduce the stability of the formulation.

### Example 5

A composition was made with 0.3% potassium ricinoleate, 0.09% SDS, 0.3% isopropyl alcohol, 0.1% phenoxetol, 0.4% terpineol, and 0.2% PCMX with the remainder deionized water. The solution was mixed gently and then homogenized. The pH was adjusted with concentrated hydrochloric acid (HCl) to pH 8.6. The particle size was determined using a Malvern Zetasizer and determined to be 547 nm and 128 nm after homogenization. By using a salt test this formulation showed less separation vs the prior art formulation.

### Example 6

A composition was made with 0.3% potassium ricinoleate, 0.06% SDS, 0.8% isopropyl alcohol, 0.4% terpineol, and 0.2% PCMX with the remainder deionized water. The solution was mixed gently and then homogenized. In several samples of this composition, the pH was adjusted with concentrated hydrochloric acid (HCl) to pH 6.9-10.0. The particle size was determined using a Malvern Zetasizer post homogenization to be 122-156 nm with the lower pH having the higher particle size. By using a salt test on this formulation the higher pH formulation was less stable and the pH of about 8.5 the most stable, with all more stable than the prior art formulation.

### Example 7

A composition was made with 0.3% potassium ricinoleate, 0.06% SDS, 0.8% isopropyl alcohol, 0.8% terpineol, and 0.2% PCMX with the remainder deionized water. The solution was mixed gently and then homogenized. In several samples of this composition the pH was adjusted with concentrated hydrochloric acid (HCl) to pH 3.8-9.8. The particle size was determined using a Malvern Zetasizer post homogenization to be 174-879 nm with the higher pHs having the higher particle sizes. By using a salt test on this formulation the higher pH formulation was less stable and the pH of about 8.0 the more stable of the formulations studied with all more stable than the prior art formulation.

### Example 8

A composition was made with 0.24% potassium ricinoleate, 0.06% SDS, 0.4% isopropyl alcohol, 0.4% terpineol, and 0.2% PCMX with the remainder deionized water. The solution was mixed gently and then homogenized. The pH was adjusted with concentrated hydrochloric acid (HCl) to pH 8.5. The particle size was determined using a Malvern Zetasizer post homogenization to be 151 nm with zeta potential of −111 mV versus −21 mV for the prior art formulation. By using a salt test on this formulation was more stable than the prior art formulation.

### Example 9

A composition was made with 0.24% potassium ricinoleate, 0.06% SDS, 0.4% isopropyl alcohol, 0.2% terpineol, and 0.2% PCMX with the remainder deionized water. The solution was mixed gently and then homogenized. In two samples of the composition the pH was adjusted with concentrated hydrochloric acid (HCl) to pH 8.5 and 7.0. The particle size was determined using a Malvern Zetasizer post homogenization to be 305 nm at pH 8.5 and 349 nm at pH 7.0. Particle size was 443 nm prior to homogenization. By using a salt test these formulations were more stable than the prior art formulation.

### Example 10

A composition was made with 0.24% potassium ricinoleate, 0.06% SDS, 0.3% isopropyl alcohol, 0.1% phenoxetol, 0.4% terpineol, and 0.2% PCMX with the remainder deionized water. The solution was mixed gently and then homogenized. In two samples of this composition the pH was adjusted with concentrated hydrochloric acid (HCl) to pH 8.5 and 7.0. The particle size was determined using a Malvern Zetasizer post homogenization to be 228 nm at pH 8.5 and 293 nm at pH 7.0. Particle size was 479 nm prior to homogenization. By using a salt test these formulations were more stable than the prior art formulation.

### Example 11

A composition was made with 0.24% potassium ricinoleate, 0.06% SDS, 0.4% isopropyl alcohol, 0.2% terpineol, and 0.2% PCMX with the remainder deionized water. The solution was mixed gently and then homogenized. In several samples of this composition the pH was adjusted with concentrated hydrochloric acid (HCl) from 6.8-8.0. The particle size was determined using a Malvern Zetasizer post homogenization to be 282 nm at pH 6.8, 217 nm at pH 7.4, and 98 nm at pH 8.0. Particle size was 338 nm prior to homogenization at pH 7.4. By using a salt test these formulations were more stable than the prior art formulation and comparable at pH 6.8-8.0 and to the formulation in Example 8 at pH 8.5.

### Example 12

A composition was made with 0.24% potassium ricinoleate, 0.06% SDS, 0.4% isopropyl alcohol, 0.3% terpineol, and 0.2% PCMX with the remainder deionized water. The solution was mixed gently and then homogenized. In several samples of this composition the pH was adjusted with concentrated hydrochloric acid (HCl) from 6.9-8.1. The particle size was determined using a Malvern Zetasizer post homogenization to be 207 nm at pH 8.1, 246 nm at pH 7.5, and 252 nm at pH 6.9. Particle size was 527 nm prior to homogenization at pH 8.8. By using a salt test these formulations were more stable than the prior art formulation and near comparable to the formulation in Example 11 at pH 7.4.

### Example 13

A composition was made with 0.24% potassium ricinoleate, 0.06% SDS, 0.4% isopropyl alcohol, 0.1% terpineol, and 0.2% PCMX with the remainder deionized water. The solution was mixed gently. While adding the water the solution turned cloudy and crystals formed and separated with mixing believed to be due to the low terpineol concentration.

### Example 14

A composition was made with 0.24% potassium ricinoleate, 0.06% SDS, 0.4% isopropyl alcohol, 0.15% terpineol, and 0.2% PCMX with the remainder deionized water. The solution was mixed gently. While adding the water the solution turned cloudy and crystals formed and separated with mixing believed to be due to the low terpineol concentration.

### Example 15

A composition was made with 0.23% potassium ricinoleate, 0.06% SDS, 0.5% isopropyl alcohol, 0.19% terpineol, and 0.27% PCMX with the remainder deionized water. The solution was mixed gently. While adding the water the solution turned cloudy and crystals formed and separated with mixing believed to be due to the low terpineol concentration.

### Example 16

A composition was made with 0.24% potassium ricinoleate, 0.06% SDS, 0.4% isopropyl alcohol, 0.2% terpineol, and 0.2% PCMX with the remainder deionized water. The solution was mixed gently and then homogenized. In several samples of this composition the pH was adjusted with concentrated hydrochloric acid (HCl) to 7.4-7.7. In two versions trisodium EDTA was added at 0.1 and 1.0%. For pH 7.6 without EDTA the particle size was 85 nm, for pH 7.7 with 0.1% EDTA the particle size was 91 nm, and for pH 7.6 with 1.0% EDTA the particle size was 284 nm. Particle size was 527 nm prior to homogenization at pH 8.8. By using a salt test these formulations were more stable than the prior art formulation. In particular the formulations at pHs 7.6 and 7.7 were the most stable.

### Example 17

A composition was made with 0.24% potassium ricinoleate, 0.06% SDS, 0.4% isopropyl alcohol, 0.2% terpineol, and 0.12% hydrogen peroxide with the remainder deionized water. The solution was mixed gently and then homogenized. The pH was adjusted to 8.5. The particle size was 291 nm. Within a day noticeable degassing of the solution occurred.

### Example 18

A composition was made with 0.24% potassium ricinoleate, 0.06% SDS, 0.4% isopropyl alcohol, 0.2% terpineol, and 0.2% PCMX with the remainder deionized water. The solution was mixed gently and then homogenized.

### Example 19

A composition was made with 0.24% potassium ricinoleate, 0.06% SDS, 0.4% isopropyl alcohol, 0.2% terpineol, and 0.2% PCMX with the remainder deionized water. The solution was mixed gently and then homogenized.

### Example 20

A composition was made with 0.24% potassium ricinoleate, 0.06% SDS, 0.4% propylene glycol, 0.2% terpineol, and 0.2% PCMX with the remainder deionized water. The solution was mixed gently and then homogenized. In two samples of this composition the pH was adjusted with concentrated hydrochloric acid (HCl) to 7.3 and 7.4. In two versions trisodium EDTA was not added in the formulation at pH 7.3 and for the formulation at pH 7.4 EDTA was added at 0.1%. For the formulation at pH 7.3 without EDTA the particle size was 240 nm and for the formulation at pH 7.4 with 0.1% EDTA the particle size was 87 nm. The addition of the EDTA significantly lowered the particle size.

Note: For the Example 20 formulations crystallization of the PCMX occurred after refrigeration. In subsequent evaluations it was determined that the crystallization is related to the terpineol concentration and that it must be a minimum of just over 0.2%. In some studies the presence of EDTA appeared to reduce the crystallization.

### Example 21

A composition was made with 0.24% potassium ricinoleate, 0.06% SDS, 0.3% isopropyl alcohol, 0.1% phenoxetol, 0.2% terpineol, and 0.2% PCMX with the remainder deionized water. The solution was mixed gently and then homogenized. In two samples of this composition the pH was adjusted with concentrated hydrochloric acid (HCl) to 7.3 and 7.4. In two versions trisodium EDTA was not added in the formulation at pH 7.3 and for the formulation at pH 7.4 was added at 0.1%. For the formulation at pH 7.3 without EDTA the particle size was 131 nm and for the formulation at pH 7.4 with 0.1% EDTA the particle size was 61 m. The addition of the EDTA significantly lowered the particle size.

### Example 22

A composition was made with 0.24% potassium ricinoleate, 0.06% SDS, 0.3% isopropyl alcohol, 0.1% phenoxetol, 0.2% terpineol, 0.04% sodium polyphosphate, and 0.2% PCMX with the remainder deionized water. The solution was mixed gently and then homogenized. The pH was adjusted with concentrated hydrochloric acid (HCl) to 7.45. Various formulations were produced from this with varying concentrations of EDTA from zero to 0.3%. At pH 7.5 the particle size was 61 nm. Without homogenization and without EDTA the pH was 8.5 and particle size of 43 nm; without homogenization and with EDTA of 0.14% the pH was 8.3 and particle size of 30 nm. By using a salt test these formulations were more stable than the prior art formulation.

Note: The major difference in this formulation was the addition of polyphosphate but leading up to this formulation particle sizes were becoming lower pre homogenization.

### Example 23

A composition was made with 0.24% potassium ricinoleate, 0.06% SDS, 0.3% isopropyl alcohol, 0.1% phenoxetol, 0.2% terpineol, 0.04% sodium polyphosphate, 0.01% ricinoleamidopropyl PG-dimonium chloride phosphate, and 0.2% PCMX with the remainder deionized water. The solution was mixed gently and homogenized. For formulations to which no EDTA was added, 0.05%, and 0.1% EDTA the particle sizes were 70 nm, 66 nm, and 64 nm and pHs were 7.4, 7.4, and 7.4 respectively. For solutions refrigerated no crystallization was noted for storage of greater than 105 days. By using a salt test these formulations were more stable than the prior art formulation.

### Example 24

A composition was made with 0.24% potassium ricinoleate, 0.06% SDS, 0.2% isopropyl alcohol, 0.2% phenoxetol, 0.1% terpineol, 0.04% sodium pyrophosphate, and 0.2% PCMX with the remainder deionized water. The solution was mixed gently. Crystals formed in the process of making the formulation (likely related to the very low terpineol concentration).

### Example 25

A composition was made with 0.24% potassium ricinoleate, 0.06% SDS, 0.3% isopropyl alcohol, 0.1% phenoxetol, 0.26% terpineol, 0.04% sodium polyphosphate, and 0.2% PCMX with the remainder deionized water. The solution was mixed gently and homogenized except for one portion. For the formulation not homogenized and to which the concentration of EDTA was 0.2%, the pH was 7.5 and particle size 71 nm. For portions of this solution with EDTA and homogenized the pH was 7.4 and the particle size 72 nm suggesting that at such a low particle size homogenization did not further reduce it. For a solution homogenized but with 0.4% EDTA the pH was 7.5 and particle size of 61 nm suggesting that increasing the EDTA concentration did not further reduce the particle size significantly. For a formulation of the same composition but with 0.25% PCMX, homogenized, with an EDTA concentration of 0.2% the pH was 7.4 and the particle size was 90 nm and for an EDTA concentration of 0.4% the pH was 7.4 and the particle size was 66 nm. No crystallization was seen in refrigerated samples for greater than 621 days. By using a salt test these formulations were more stable than the prior art formulation.

### Example 26

A composition was made with 0.24% potassium ricinoleate, 0.06% SDS, 0.3% isopropyl alcohol, 0.1% phenoxetol, 0.22% terpineol, 0.04% sodium polyphosphate, and 0.2% PCMX with the remainder deionized water. The solution was mixed gently only. The pH was adjusted with hydrochloric acid (HCl) and EDTA added to 0.2%. The pH was 7.4 and particle size 69 nm. No crystallization was noted in refrigerated samples for greater than 531 days. By using a salt test these formulations were more stable than the prior art formulation.

### Example 27

A composition was made with 0.24% potassium ricinoleate, 0.06% SDS, 0.3% isopropyl alcohol, 0.1% phenoxetol, 0.2% terpineol, 0.04% sodium polyphosphate, and 0.2% PCMX with the remainder deionized water. The solution was mixed gently only. The pH was adjusted with hydrochloric acid (HCl) and EDTA added to 0.2%. The pH was 7.4 and particle size 78 nm. Crystallization was noted in refrigerated samples at 16 days likely related to the lower terpineol concentration. By using a salt test these formulations were more stable than the prior art formulation.

### Example 28

A composition was made with 0.24% potassium ricinoleate, 0.06% SDS, 0.3% isopropyl alcohol, 0.1% phenoxetol, 0.21% terpineol, 0.04% sodium polyphosphate, and 0.2% PCMX with the remainder deionized water. The solution was mixed gently only. The pH was adjusted with hydrochloric acid (HCl) and EDTA added to 0.2%. The pH was 7.4 and particle size 64 nm. Crystallization was noted in refrigerated samples at 29 days likely related to the lower terpineol concentration. By using a salt test these formulations were more stable than the prior art formulation.

### Example 29

A composition was made with 0.24% potassium ricinoleate, 0.06% SDS, 0.3% isopropyl alcohol, 0.1% phenoxetol, 0.25% terpineol, 0.04% sodium polyphosphate, and 0.2% PCMX with the remainder deionized water. The solution was mixed gently only. The pH was adjusted with hydrochloric acid (HCl) and EDTA added to 0.2%. The pH was 7.4 and particle size 68 nm. Crystallization was not noted in refrigerated samples for over 579 days likely related to the higher terpineol concentration. By using a salt test these formulations were more stable than the prior art formulation.

### Example 30

A composition was made with 0.19% potassium ricinoleate, 0.05% SDS, 0.32% phenoxetol, 0.17% terpineol, 0.03% sodium polyphosphate, and 0.16% PCMX with the remainder deionized water. The solution was mixed gently only. The pH was adjusted with hydrochloric acid (HCl). To a portion no EDTA was added and the pH was 7.4 and particle size 71 nm. To another portion EDTA was added to 0.2% EDTA and the pH was 7.5 and particle size 66 nm. Crystallization was not noted in refrigerated samples for over 564 days.

### Example 31

A composition was made with 0.24% potassium ricinoleate, 0.06% SDS, 0.1% isopropyl alcohol, 0.3% phenoxetol, 0.22% terpineol, and 0.2% PCMX with the remainder deionized water. The solution was mixed gently only. The pH was adjusted with hydrochloric acid (HCl). To a portion of the mix no EDTA was added and to another portion EDTA was added at 0.1%. For the non-EDTA portion the pH was 7.4 and particle size 70 nm. For the portion to which EDTA was added the pH was 7.4 and the particle size 63 nm. For each solution no crystallization was noted following refrigeration of the samples for greater than 563 days.

### Example 32

A composition was made with 0.24% potassium ricinoleate, 0.06% SDS, 0.2% isopropyl alcohol, 0.2% phenoxetol, 0.22% terpineol, and 0.2% PCMX with the remainder deionized water. The solution was mixed gently only. The pH was adjusted with hydrochloric acid (HCl). To a portion of the mix no EDTA was added and to another portion EDTA was added at 0.2%. For the non-EDTA portion the pH was 7.4 and particle size 68 nm. For the portion to which EDTA was added the pH was 7.5 and the particle size 60 nm. For each solution no crystallization was noted following refrigeration of the samples for greater than 560 days.

### Example 33

A composition was made with 0.24% potassium ricinoleate, 0.06% SDS, 0.3% isopropyl alcohol, 0.1% phenoxetol, 0.22% terpineol, 0.04% sodium polyphosphate, and 0.3% PCMX with the remainder deionized water. The solution was mixed gently only. The pH was adjusted with hydrochloric acid (HCl). Crystallization in the solution occurred while mixing and it was noted that the amount of terpineol in the concentrate was under that required. The additional terpineol was added during the RTU (ready-to-use) build. The pH was 7.4 and the particle size was 127 nm for this solution at about 0.3% PCMX. No crystallization was noted following refrigeration of the samples for greater than 554 days.

### Example 34

A composition was made with 0.24% potassium ricinoleate, 0.06% SDS, 0.3% isopropyl alcohol, 0.1% phenoxetol, 0.22% terpineol, 0.01% ricinoleamidopropyl PG-dimonium chloride phosphate, and 0.2% PCMX with the remainder deionized water. The solution was mixed gently only. The pH was adjusted with hydrochloric acid (HCl). To a portion of the mix no EDTA was added and to another portion EDTA was added at 0.1%. For the non-EDTA portion the pH was 7.4 and particle size 86 nm. For the portion to which EDTA was added the pH was 7.3 and the particle size 74 nm. Crystallization in the solution occurred while mixing and it was noted that the amount of terpineol in the concentrate was under that required. The additional terpineol was added during the RTU build. The pH was 7.4 and the particle size was 127 nm for this solution at about 0.3% PCMX. No crystallization was noted following refrigeration of the samples for greater than 549 days.

### Example 35

A composition was made with 0.24% potassium ricinoleate, 0.06% SDS, 0.3% isopropyl alcohol, 0.1% phenoxetol, 0.22% terpineol, 0.04% ricinoleamidopropyl PG-dimonium chloride phosphate, and 0.2% PCMX with the remainder deionized water. The solution was mixed gently only. The pH was adjusted with hydrochloric acid (HCl) and then EDTA added to 0.1%. The pH was 7.3 and the particle size 89 nm. No crystallization was noted following refrigeration of the samples for greater than 547 days.

### Example 36

A composition was made with 0.24% potassium ricinoleate, 0.06% SDS, 0.06% polyoxyethylenesorbitan monopalmitate 40, 0.3% isopropyl alcohol, 0.1% phenoxetol, 0.22% terpineol, and 0.2% PCMX with the remainder deionized water. The solution was mixed gently only. The pH was adjusted with hydrochloric acid (HCl) and then EDTA added to 0.2%. The pH was 7.4 and the particle size 81 nm. No crystallization was noted following refrigeration of the samples for greater than 541 days.

### Example 37

A concentrate was built for the eventual RTU concentrations with 0.24% cetylpyridinium chloride, 0.12% benzyltrimethyl ammonium chloride, 0.04% cocamidopropyl PG-dimonium chloride phosphate, 0.3% isopropyl alcohol, 0.1% phenoxetol, 0.22% terpineol, and 0.2% PCMX. This concentrated emulsion separated out and the RTU was not built.

### Example 38

A composition was made with 0.24% potassium ricinoleate, 1.2% mixture of PEG-8 laurate with laureth-4 and PCMX with resultant concentration of 0.2% PCMX with the remainder deionized water. The solution was mixed gently only. The pH was adjusted with hydrochloric acid (HCl) and then EDTA added to 0.1%. The pH was 7.4 and the particle size 118 nm. No crystallization was noted following refrigeration of the samples for greater than 544 days.

### Example 39

A composition was made with 0.24% potassium ricinoleate, 0.06% SDS, 0.3% isopropyl alcohol, 0.1% phenoxetol, 0.22% terpineol, 0.04% sodium polyphosphate, 1.57% multi-enzyme based solution, and 0.2% PCMX with the remainder deionized water. The solution was mixed gently only. The pH was adjusted with hydrochloric acid

(HCl) and EDTA added to 0.2%. The pH was 7.2 and particle size 121 nm. No crystallization was noted in refrigerated samples for greater than 536 days.

### Example 40

A composition was made with 0.24% potassium ricinoleate, 0.06% SDS, 0.35% isopropyl alcohol, 0.05% phenoxetol, 0.22% terpineol, 0.04% sodium polyphosphate, and 0.2% PCMX with the remainder deionized water. The solution was mixed gently only. The pH was adjusted with hydrochloric acid (HCl) and EDTA was added to 0.2%. The pH was 7.4 and particle size 63 nm. No crystallization was noted in refrigerated samples for greater than 810 days. In a second build the pH was 7.4 and the particle size was 62 nm and zeta potential −99 mV. No crystallization was noted in refrigerated samples for greater than 776 days. In a third build the pH was 7.4 and the particle size was 61 nm. No crystallization was noted in refrigerated samples for greater than 771 days. In a fourth build the pH was 7.4, the particle size 66 nm, and the zeta potential −106 mV. No crystallization was noted in refrigerated samples for greater than 741 days. In a fifth build the sodium polyphosphate was 0.24%, pH 7.3, the particle size 66 nm, and the zeta potential −133 mV. No crystallization was noted in refrigerated samples for greater than 706 days. In a sixth build the sodium polyphosphate was 0.25%, the pH 7.3, the particle size 73 nm, and the zeta potential −132 mV. No crystallization was noted in refrigerated samples for greater than 695 days. In a seventh build the sodium polyphosphate was 0.25%, the pH 7.3, the particle size 69 nm, and the zeta potential −119 mV. No crystallization was noted in refrigerated samples for greater than 694 days. In an eighth build the amount of concentrate added to make the RTU was increased by 25% to give a PCMX of about 0.25%. In one portion the pH was adjusted to 8.5 and the particle size was 12 nm and the zeta potential −92 mV. For a second portion the pH was 7.6, the particle size 172 nm, and the zeta potential −106 mV. No crystallization was noted in refrigerated samples for greater than 678 days.

### Example 41

A composition was made with 0.24% potassium ricinoleate, 0.3% isopropyl alcohol, 0.1% phenoxetol, 0.22% terpineol, 0.05% sodium hydroxypropylsulfonate lauryl-glucoside crosspolymer, 0.04% sodium polyphosphate, and 0.2% PCMX with the remainder deionized water. The solution was mixed gently only. The pH was adjusted with hydrochloric acid (HCl) and an additional 0.21% sodium polyphosphate added (total was 0.25%) and 0.2% EDTA added. The pH was 7.4, the particle size 195 nm, and zeta potential −89 mV. No crystallization was noted in refrigerated samples for greater than 804 days.

### Example 42

A composition was made with 0.24% potassium ricinoleate, 0.06% SDS, 0.35% isopropyl alcohol, 0.05% phenoxetol, 0.22% terpineol, 0.04% sodium polyphosphate, and 0.2% PCMX with the remainder deionized water. The solution was mixed gently only. 0.05% tetrasodium 1-hydroxyethylidene-1,1-diphosphonate (bis-phosphonate) then 0.2% EDTA and then the pH was adjusted with hydrochloric acid (HCl). The pH was 7.7, the particle size 70 nm, and the zeta potential −105 mV. No crystallization was noted in refrigerated samples for greater than 792 days. In a second build the pH was 7.7, the particle size was 79 nm, and zeta potential −98 mV. No crystallization was noted in refrigerated samples for greater than 776 days. In a third build the pH was 7.7, the particle size was 81 nm, and the zeta potential −98 nm. No crystallization was noted in refrigerated samples for greater than 771 days. In a fourth build an additional sodium polyphosphate was added to bring total to 0.125% and bis-phosphonate total was 0.025% the pH was 8.5, the particle size 9 nm, and the zeta potential −100 mV. No crystallization was noted in refrigerated samples for greater than 684 days. In a fifth build the final concentration of EDTA was 0.2% EDTA. Samples were prepared with various pHs of 8.5, 7.4, and 6.9 with particle sizes of 9, 227, and 294 nm respectively; and zeta potentials of −54, −107, and −82 mV. No crystallization was noted in refrigerated samples for greater than 671 days.

In a sixth build the final concentration of sodium xylenesulfonate was 0.2% and the EDTA 0.2%; the pH was 7.6, the particle size 59 nm, and the zeta potential −99 mV. Crystallization was noted in refrigerated samples at 9 days. In a seventh build a portion was made with 0.2% EDTA and the pH was 7.4, the particle size 66 nm, and the zeta potential −103 mV; in a second portion the final EDTA was 0.4% EDTA and the pH 7.5, the particle size 59 nm, and the zeta potential −106 mV. No crystallization was noted in refrigerated samples for greater than 576 days. In an eighth build the final EDTA was 0.2% and the final PCMX was about 0.22%. No crystallization was noted in refrigerated samples for greater than 531. By using a salt test the first built formulation was more stable than the prior art formulation.

### Example 43

A composition was made with 0.24% potassium ricinoleate, 0.06% SDS, 0.35% isopropyl alcohol, 0.05% phenoxetol, 0.22% terpineol, 0.04% sodium polyphosphate, and 0.3% PCMX with the remainder deionized water. The solution was mixed gently only during the build but the crystals appeared during the mixing before all the concentrate was added very likely related to the higher PCMX concentration and the higher PCMX:terpineol ratio.

### Example 44

A composition was made with 0.24% potassium ricinoleate, 0.06% SDS, 0.35% isopropyl alcohol, 0.05% phenoxetol, 0.33% terpineol, 0.04% sodium polyphosphate, and 0.3% PCMX with the remainder deionized water. The solution was mixed gently only. Bis-phosphonate was added to a final concentration of 0.05% and EDTA was added to a final concentration of 0.2% and then the pH was adjusted with hydrochloric acid (HCl). The pH was 7.7, the particle size 187 nm, and the zeta potential −116 mV. At 2 days crystals were seen in the refrigerated sample likely related to the higher PCMX concentration.

### Example 45

A concentrate with a projected RTU composition with about 0.24% potassium ricinoleate, 0.06% SDS, 0.35% isopropyl alcohol, 0.05% phenoxetol, 0.22% terpineol, 0.25% sodium polyphosphate, and 0.2% PCMX was made but the formulation separated before the RTU could be made likely related to the high concentration of the sodium polyphosphate used.

### Example 46

A composition was made with 0.24% potassium ricinoleate, 0.06% SDS, 0.35% isopropyl alcohol, 0.05% phenoxetol, 0.22% terpineol, and 0.2% PCMX with the remainder deionized water. The solution was mixed gently only and sodium polyphosphate (n=21) added at a final concentration of 0.1% and then EDTA added at a final concentration of 0.2% and then the pH adjusted with hydrochloric acid in two portions to 8.1 and 7.4. The particle sizes were 38 nm and 61 nm respectively. Notably in this example and others, the higher the pH the lower the particle size. The zeta potentials were −81 and −99 mV respectively. In a second build made without polyphosphate and an EDTA final concentration of 0.2% and the pH adjusted with hydrochloric acid to a pH of 7.4, the particle size was 62 nm and the zeta potential −93 mV. A third build was made with no polyphosphate but with 0.03% bis-phosphonate and the pH adjusted with hydrochloric acid to 7.4. The particle size was 193 nm and the zeta potential −112 mV. For these formulations no crystallization was noted in refrigerated samples for greater than 598 days.

### Example 47

### Prior Art Formulation but at Higher Concentration

A composition was made using the concentrate formulation as that used for the prior art product but at 1.9 times the concentrate volume typically used. The final composition was about 0.46% potassium ricinoleate, 0.76% isopropyl alcohol, 0.76% terpineol, and 0.38% PCMX with the remainder deionized water. The solution was mixed gently only and then the pH adjusted with hydrochloric acid to 8.5. The particle size was 275 nm and the zeta potential −1.69 mV. While a higher concentration of the concentrate was used this formulation showed a high particle size in the absence of homogenization and a low zeta potential. For this formulation no crystallization was noted in refrigerated samples for greater than 644 days.

### Example 48

A composition was made with 0.18% potassium ricinoleate, 0.06% SDS, 0.35% isopropyl alcohol, 0.05% phenoxetol, 0.22% terpineol, and 0.2% PCMX with the remainder deionized water. The solution was mixed gently only and sodium polyphosphate (n=13) added at a final concentration of 0.04% and then EDTA added at a final concentration of 0.2% and then the pH adjusted with hydrochloric acid to 7.7. The particle size was 50 nm and the zeta potential −88 mV. For this formulation crystals were noted in refrigerated samples at 9 days. This crystallization was believed related to the lower potassium ricinoleate used in the formulation.

### Example 49

A composition was formulated with 0.24% potassium ricinoleate, 1.16% polyoxyethylenesorbitan monopalmitate 40, and 0.2% PCMX with the remainder deionized water. The solution was mixed gently only and sodium polyphosphate (n=13) added at a final concentration of 0.04% and then EDTA added at a final concentration of 0.2% and then the pH adjusted with citric acid to 7.3. The particle size was 113 nm and the zeta potential −32 mV. For this formulation crystals were not noted in refrigerated samples at 623 days.

### Example 50

A composition with the intended concentration of 0.24% potassium ricinoleate, 0.06% SDS, 0.53% isopropyl alcohol, 0.08% phenoxetol, 0.22% terpineol, and 0.3% PCMX with the remainder deionized water. With the addition of the concentrate crystals were formed and the build aborted. The reason for the crystallization is likely related to the high PCMX: terpineol ratio.

### Example 51

A composition was formulated by adding directly to the water a blend of sodium laureth sulfate, D-glucopyranoside, C-6-12-alkyl, oligome, ethanol, and PCMX with the expected final concentration of PCMX of 0.2%. During the build a precipitate was formed around the pH electrode and the run was aborted.

### Example 52

A composition was made with 0.24% potassium ricinoleate, 0.06% SDS, 0.35% isopropyl alcohol, 0.05% phenoxetol, 0.22% terpineol, 0.074% essential oil tea tree heart, and 0.2% PCMX with the remainder deionized water. The solution was mixed gently only and then the pH adjusted with hydrochloric acid to 8.5. The particle size was 73 nm and the zeta potential was −104 mV. No crystallization was noted in refrigerated samples for greater than 595 days.

### Example 53

### Prior Art Formulation but at Higher Concentration

A composition was made using the concentrate formulation as that used for the prior art product but at 1.7 times the concentrate volume typically used. The final composition was about 0.41% potassium ricinoleate, 0.68% isopropyl alcohol, 0.68% terpineol, and 0.34% PCMX with the remainder deionized water. The solution was mixed gently only and then the pH adjusted with hydrochloric acid to 8.5. The particle size was 281 nm and the zeta potential −3.46 mV. While a higher concentration of the concentrate was used this formulation showed a high particle size in the absence of homogenization and a low zeta potential. For this formulation no crystallization was noted in refrigerated samples for greater than 589 days.

### Example 54

A composition was made with 0.24% potassium ricinoleate, 0.06% SDS, 0.35% isopropyl alcohol, 0.05% phenoxetol, 0.22% of the essential oil tea tree heart, 0.04% sodium polyphosphate, and 0.2% PCMX with the remainder deionized water. The solution was mixed gently only and then EDTA added. Then crystals were noted in the solution. Then terpineol was added to a final concentration of 0.22% and then adjusted the pH with hydrochloric acid to a final pH of 7.8. The particle size was 80 nm and the zeta potential −93 mV. For this formulation no crystallization was noted in refrigerated samples for greater than 581 days. In a second build the terpineol was added directly to the concentrate before adding to the water to a final concentration in the RTU of 0.11%. The pH was adjusted with hydrochloric acid to a pH of 7.7. The particle size was 67 nm and the zeta potential −90 mV. For this formulation no crystallization was noted in refrigerated samples for greater than 581 days. In a third build the RTU was pH adjusted with hydrochloric acid and then EDTA added to a final concentration of 0.2%. The pH was 7.6, the particle size 52 nm, and the zeta potential −54 mV. For this formulation no crystallization was noted in refrigerated samples for greater than 577 days.

### Example 55

### Prior Art Formulation but at Higher Concentration

A composition was made using the concentrate formulation as that used for the prior art product but at 1.75 times the concentrate volume typically used. The final composition was 0.42% potassium ricinoleate, 0.7% isopropyl alcohol, 0.7% terpineol, and 0.35% PCMX with the remainder deionized water. The solution was mixed gently only and then the pH adjusted with hydrochloric acid to 8.5. The particle size was 276 nm and the zeta potential −2.96 mV. While a higher concentration of the concentrate was used, this formulation showed a high particle size in the absence of homogenization and a low zeta potential. For this formulation no crystallization was noted in refrigerated samples for greater than 575 days.

### Example 56

A composition was made with 0.24% potassium ricinoleate, 0.06% SDS, 0.35% isopropyl alcohol, 0.05% phenoxetol, 0.22% terpineol, 0.04% sodium polyphosphate, and 0.2% PCMX with the remainder deionized water. The solution was mixed gently only and the pH was adjusted with citric acid and EDTA added to a final concentration of 0.3%. The pH was 7.9, the particle size 39 nm, and the zeta potential −84 mV. For this formulation no crystallization was noted in refrigerated samples for greater than 559 days. In a second build the pH was adjusted with citric acid and EDTA added to a final concentration of 0.4%. The pH was 7.9, the particle size was 62 nm, and the zeta potential −107 mV. For this formulation no crystallization was noted in refrigerated samples for greater than 556 days. In a third build the pH was adjusted with citric acid and EDTA added to a final concentration of 0.5%. The pH was 7.9, the particle size was 25 nm, and the zeta potential −120 mV. For this formulation no crystallization was noted in refrigerated samples for greater than 555 days.

### Example 57

A composition was made with 0.24% potassium ricinoleate, 0.03% SDS, 0.35% isopropyl alcohol, 0.05% phenoxetol, 0.22% terpineol, 0.04% sodium polyphosphate, and 0.2% PCMX with the remainder deionized water. The solution was mixed gently only and the pH was adjusted with hydrochloric acid and EDTA added to a final concentration of 0.2%. The pH was 8.0, the particle size 62 nm, and the zeta potential −100 mV. For this formulation no crystallization was noted in refrigerated samples for greater than 547 days. In a second build the pH was adjusted with hydrochloric acid and EDTA added to a final concentration of 0.2% and trisodium nitrilotriacetic acid added to a final concentration of 0.1%. The pH was 8.49, the particle size was 29 nm, and the zeta potential −101 mV. For this formulation no crystallization was noted in refrigerated samples for greater than 542 days where the sample was in a glass bottle and crystals were seen at 546 days when the sample was stored in HDPE.

### Example 58

A concentrate was built with an RTU of 0.24% SDS, 0.35% isopropyl alcohol, 0.05% phenoxetol, 0.22% terpineol, 0.04% sodium polyphosphate, and 0.2% PCMX. During the build when the polyphosphate was added the pH dropped below 7 and it was adjusted upward with concentrated potassium hydroxide. In time this formulation showed separation and in a trial RTU a precipitate formed and the trial aborted. This was likely related to the absence of potassium ricinoleate in the formulation.

### Example 59

A composition was made with 0.24% potassium ricinoleate, 0.06% SDS, 0.35% isopropyl alcohol, 0.05% phenoxetol, 0.22% terpineol, 0.04% sodium polyphosphate, and 0.2% mixed phenols (0.05% PCMX, 0.05% 2-benzl-4-chlorophenol, 0.05% para tertiary amylphenol, and 0.05% ortho-phenyl-phenol) with the remainder deionized water. The solution was mixed gently only and the pH was adjusted with hydrochloric acid and EDTA added to a final concentration of 0.2%. The pH was 7.9, the particle size 52 nm, and the zeta potential −85 mV. For this formulation no crystallization was noted in refrigerated samples for greater than 535 days.

### Example 60

### Prior Art Formulation but at Higher Concentration

A composition was made using the concentrate formulation as that used for the prior art product but at 1.6 times the concentrate volume typically used. The final composition was 0.38% potassium ricinoleate, 0.64% isopropyl alcohol, 0.64% terpineol, and 0.32% PCMX with the remainder deionized water. The solution was mixed gently only and then the pH adjusted with hydrochloric acid to 8.5. The particle size was 261 nm and the zeta potential −4.56 mV. While a higher concentration of the concentrate was used, this formulation showed a high particle size in the absence of homogenization and a low zeta potential.

### Example 61

### Prior Art Formulation but at Higher Concentration

A composition was made using the same concentrate formulation as that used for the prior art product but at 1.725 times the concentrate volume typically used. The final composition was 0.41% potassium ricinoleate, 0.69% isopropyl alcohol, 0.69% terpineol, and 0.345% PCMX with the remainder deionized water. The solution was mixed gently only and then the pH adjusted with hydrochloric acid to 8.5. The particle size was 274 nm and the zeta potential −3.01 mV. While a higher concentration of the concentrate was used, this formulation showed a high particle size in the absence of homogenization and a low zeta potential.

### Example 62

A composition was made with 0.24% potassium ricinoleate, 0.06% SDS, 0.35% isopropyl alcohol, 0.05% phenoxetol, 0.22% terpineol, 0.04% sodium polyphosphate, and 0.22% PCMX with the remainder deionized water. The solution was mixed gently only and the pH was adjusted with hydrochloric acid and EDTA added to a final concentration of 0.2%. The pH was 7.4, the particle size 59 nm, and the zeta potential −101 mV. For this formulation no crystallization was noted in refrigerated samples for greater than 503 days. In a second build made similarly, the pH was 7.4, the particle size 60 nm, and the zeta potential −103 mV. For this formulation no crystallization was noted in refrigerated samples for greater than 500 days.

### Example 63

A composition was made with 0.012% potassium ricinoleate, 0.02% isopropyl alcohol, 0.02% terpineol, and 0.01% PCMX with the remainder deionized water. The solution was mixed gently only and the pH was not adjusted. The pH was 7.3, the particle size 22 nm, and the zeta potential −0.623 mV. For this formulation no crystallization was noted in refrigerated samples for greater than 374 days.

### Example 64

Left blank intentionally

### Example 65

A composition was made with 0.24% potassium ricinoleate, 0.06% SDS, 0.35% isopropyl alcohol, 0.05% phenoxetol, 0.22% terpineol, 0.04% sodium polyphosphate, and 0.22% PCMX with the remainder deionized water. The solution was mixed gently only and the pH was adjusted with hydrochloric acid and EDTA added to a final concentration of 0.2%. The pH was 7.4, the particle size 56 nm, and the zeta potential −98 mV. For this formulation crystallization was noted in refrigerated samples at 224 days. In a second build the PCXM concentration was about 0.353% and the other components increased proportionally. The pH was 7.9, the particle size 51 nm, and the zeta potential −100 mV. For this formulation crystallization was not noted in refrigerated samples at 465 days.

### Example 66

A composition was made with 0.24% potassium ricinoleate, 0.06% SDS, 0.35% isopropyl alcohol, 0.05% phenoxetol, 0.26% terpineol, 0.04% sodium polyphosphate, and 0.22% PCMX with the remainder deionized water. The solution was mixed gently only and the pH was adjusted with hydrochloric acid and EDTA added to a final concentration of 0.2%. The pH was 7.5, the particle size 60 nm, and the zeta potential −95 mV. For this formulation crystallization was noted in refrigerated samples at 478 days. In a second build the PCXM concentration was about 0.353% and the other components increased proportionally. The pH was adjusted with hydrochloric acid and EDTA added to a final concentration of 0.2%. The pH was 7.9, the particle size 55 nm, and the zeta potential −102 mV. For this formulation no crystallization was noted in refrigerated samples for greater than 464 days. In a third build the PCXM concentration was about 0.27% and the other components increased proportionally. The pH was adjusted with hydrochloric acid and EDTA added to a final concentration of 0.2%. The pH was 7.9, the particle size 56 nm, and the zeta potential −95 mV. For this formulation no crystallization was noted in refrigerated samples for greater than 448 days. In a fourth build (like the third build) the PCXM concentration was 0.27% and the other components increased proportionally. The pH was adjusted with hydrochloric acid and EDTA added to a final concentration of 0.2%. The pH was 7.9, the particle size 53 nm, and the zeta potential −95 mV. For this formulation no crystallization was noted in refrigerated samples for greater than 435 days. In a fifth build the PCXM concentration was 0.30% and the other components increased proportionally. The pH was adjusted with hydrochloric acid and EDTA added to a final concentration of 0.2%. The pH was 7.9, the particle size 59 nm, and the zeta potential −99 mV. For this formulation no crystallization was noted in refrigerated samples for greater than 426 days. In a sixth build (like fifth build) the PCXM concentration was 0.30% and the other components increased proportionally. The pH was adjusted with hydrochloric acid and EDTA added to a final concentration of 0.2%. The pH was 7.9, the particle size 59 nm, and the zeta potential −100 mV.

### Example 67

A composition was made with 0.24% potassium ricinoleate, 0.06% SDS, 0.47% isopropyl alcohol, 0.07% phenoxetol, 0.29% terpineol, 0.04% sodium polyphosphate, and 0.27% PCMX with the remainder deionized water. The solution was mixed gently only and the pH was adjusted with hydrochloric acid and EDTA added to a final concentration of 0.2%. The pH was 7.9, the particle size 58 nm, and the zeta potential −99 mV. For this formulation crystallization was noted in refrigerated samples at 9 days.

### Example 68

A composition was made with 0.36% potassium ricinoleate, 0.09% SDS, 0.53% isopropyl alcohol, 0.075% phenoxetol, 0.45% terpineol, 0.06% sodium polyphosphate, and 0.3% PCMX with the remainder deionized water. The solution was mixed gently only and the pH was adjusted with hydrochloric acid and EDTA added to a final concentration of 0.2%. The pH was 7.9, the particle size 62 nm, and the zeta potential −100 mV. For this formulation crystallization was not noted in refrigerated samples at 420 days. In a second build the composition made was 0.32% potassium ricinoleate, 0.08% SDS, 0.47% isopropyl alcohol, 0.07% phenoxetol, 0.41% terpineol, 0.05% sodium polyphosphate, and 0.27% PCMX with the remainder deionized water. The solution was mixed gently only and the pH was adjusted with hydrochloric acid and EDTA added to a final concentration of 0.2%. The pH was 7.9, the particle size 61 nm, and the zeta potential −101 mV. For this formulation crystallization was not noted in refrigerated samples at 380 days.

### Example 69

Left blank intentionally

### Example 70

A composition was made with 0.01% potassium ricinoleate, 0.02% propylene glycol, 0.02% terpineol, and 0.01% PCMX with the remainder deionized water. The solution was mixed gently only and the pH was not adjusted. The pH was 7.5, the particle size 23 nm, and the zeta potential −86 mV. For this formulation crystallization was not noted in refrigerated samples at 374 days.

### Example 71

Left blank intentionally

### Example 72

A composition was made with 0.3% potassium ricinoleate, 0.075% SDS, 0.44% isopropyl alcohol, 0.06% phenoxetol, 0.273% terpineol, 0.05% sodium polyphosphate, and 0.25% PCMX with the remainder deionized water. The solution was mixed gently only and the pH was adjusted with hydrochloric acid and EDTA added to a final concentration of 0.2%. The pH was 7.8, the particle size 80 nm, and the zeta potential −108 mV. For this formulation crystallization was noted in refrigerated samples at 289 days. A second composition was formulated with similar chemistries except to the solution was added 0.1% 3-(trihydroxysilyl) propyldimethyloctadecyl ammonium chloride. The pH was adjusted with hydrochloric acid and EDTA added to a final concentration of 0.2%. The pH was 7.6, the particle size 769 nm, and the zeta potential −35 mV. For this formulation no crystallization was noted in refrigerated samples at 274 days. A third composition was formulated with similar chemistries (and like the second formulation) and 0.1% 3-(trihydroxysilyl) propyldimethyloctadecyl ammonium chloride was added. The pH was adjusted with hydrochloric acid and EDTA added to a final concentration of 0.2%. The pH was 7.8, the particle size 565 nm, and the zeta potential −35 mV. For this formulation no crystallization was noted in refrigerated samples at 273 days. A fourth composition was formulated with 0.3% potassium ricinoleate, 0.075% SDS, 0.44% isopropyl alcohol, 0.06% phenoxetol, 0.273% terpineol, 0.05% sodium polyphosphate, and 0.25% PCMX with the remainder deionized water. The solution was mixed gently only and the pH was adjusted with hydrochloric acid and EDTA added to a final concentration of 0.2%. The pH was 7.8, the particle size 87 nm, and the zeta potential −110 mV. For this formulation crystallization was not noted in refrigerated samples at 176 days.

### Example 73

A composition was made with 0.3% potassium ricinoleate, 0.075% SDS, 0.44% isopropyl alcohol, 0.06% phenoxetol, 0.273% terpineol, 0.05% sodium polyphosphate, and 0.25% PCMX with the remainder deionized water. The solution was mixed gently only and the pH was adjusted with hydrochloric acid and EDTA added to a final concentration of 0.2%. The pH was 7.8, the particle size 80 nm, and the zeta potential −101 mV. For this formulation crystallization was not noted in refrigerated samples at 288 days.

### Example 74

A composition was made with 0.3% potassium ricinoleate, 0.075% SDS, 0.44% isopropyl alcohol, 0.06% phenoxetol, 0.26% terpineol, 0.01% lemongrass essential oil, 0.05% sodium polyphosphate, and 0.25% PCMX with the remainder deionized water. The solution was mixed gently only and the pH was adjusted with hydrochloric acid and EDTA added to a final concentration of 0.2%. The pH was 7.9, the particle size 49 nm, and the zeta potential −99 mV. For this formulation crystallization was not noted in refrigerated samples at 48 days but crystals were seen at 140 days.

### Example 75

A composition (like that of Example 74 except a different manufacturer's lemongrass essential oil was used) with about 0.3% potassium ricinoleate, 0.075% SDS, 0.44% isopropyl alcohol, 0.06% phenoxetol, 0.26% terpineol, 0.01% lemongrass essential oil, 0.05% sodium polyphosphate, and 0.25% PCMX with the remainder deionized water. The solution was mixed gently only and the pH was adjusted with hydrochloric acid and EDTA added to a final concentration of 0.2%. The pH was 7.7, the particle size 48 nm, and the zeta potential −103 mV. For this formulation crystallization was not noted in refrigerated samples at 133 days.

### Example 76

Left blank intentionally

### Example MT1

A composition was made with 0.3% potassium ricinoleate, 0.075% SDS, 0.44% isopropyl alcohol, 0.06% phenoxetol, 0.273% terpineol, 0.05% sodium polyphosphate, and 0.25% PCMX with the remainder deionized water. The solution was mixed gently only and the pH was adjusted with hydrochloric acid and EDTA added to a final concentration of 0.2%. The pH was 7.9, the particle size 67 nm, and the zeta potential −96 mV. A second formulation was made with similar properties as that of the first build. The solution was mixed gently only and the pH was adjusted with hydrochloric acid and EDTA added to a final concentration of 0.2%. The pH was 8.0, the particle size 64 nm, and the zeta potential −106 mV. A third formulation was made with similar properties as that of the first and second builds. The solution was mixed gently only and the pH was adjusted with hydrochloric acid and EDTA added to a final concentration of 0.2%. The pH was 7.9, the particle size 71 nm, and the zeta potential −99 mV. In evaluating these solutions over time pHs, particle sizes and zeta potential were stable. In microbiological analyses per the AOAC Use Dilution tests in an independent lab these lots passed for Staphylococcus aureus (ATCC 6538), Pseudomonas aeruginosa (ATCC 15442), and Salmonella enterica (ATCC 10708) with an organic load in at most 10 minutes. In addition, this formulation tested in an independent lab passed the acute eye irritation test and met criteria for Toxicity Category IV. The first formulation was tested in the presence of 5% fetal bovine serum in an independent lab per the AOAC Germicidal Spray Method. At about 10 minutes contact time there were no positives in 60 carriers tested; at about 5 minutes there were two carriers positive in 60 carriers tested. All three formulations were evaluated in an independent laboratory in a GLP study per the AOAC Germicidal Spray Method. The organisms Staphylococcus aureus (ATCC 6538), Pseudomonas aeruginosa (ATCC 15442), and Salmonella enterica (ATCC 10708) were assessed at 9 minutes and 45 seconds at room temperature (20° C.) with 5% fetal bovine serum organic soil. The carrier counts were: Staphylococcus aureus=5.4×10⁶ CFU/carrier, Pseudomonas aeruginosa=4.6×10⁶ CFU/carrier, and Salmonella enterica=4.4×10⁵ CFU/carrier. For lot #1 Staphylococcus aureus=0/60 subculture tubes demonstrated growth of the test organism PASSED), Pseudomonas aeruginosa=0/60 subculture tubes demonstrated growth of the test organism (PASSED), Salmonella enterica=0/60 subculture tubes demonstrated growth of the test organism (PASSED). For the second lot Staphylococcus aureus=0/60 subculture tubes demonstrated growth of the test organism (PASSED), Pseudomonas aeruginosa=0/60 subculture tubes demonstrated growth of the test organism (PASSED), Salmonella enterica=0/60 subculture tubes demonstrated growth of the test organism (PASSED). For the third lot Staphylococcus aureus=0/60 subculture tubes demonstrated growth of the test organism (PASSED), Pseudomonas aeruginosa=0/60 subculture tubes demonstrated growth of the test organism (PASSED), Salmonella enterica=0/60 subculture tubes demonstrated growth of the test organism (PASSED). Two lots of this formulation were evaluated in an independent laboratory per US EPA approved methods by a germicidal spray test for a virucide for Influenza A virus (ATCC VR-544, Strain Hong Kong at 5 minutes, room temperature (20° C.) with 5% fetal bovine serum organic soil. These two lots evaluated against carriers with carrier counts of 6.75×10⁶ CFU/carrier showed PASSED with greater than or equal to 6.25 log reductions. Two lots of this formulation were evaluated in an independent laboratory per US EPA approved fungicidal germicidal spray for Candida albicans (ATCC 10231) at 9 minutes and 45 seconds at room temperature (23.5° C.) with 5% fetal bovine serum organic soil. These lots evaluated against carriers with carrier counts of 0.62×10⁵CFU/carrier showed PASSED with demonstrated efficacy. Two lots of this formulation were evaluated in an independent laboratory per US EPA approved methods by a germicidal spray test for a virucide for Avian Influenza A virus (H3N2, ATCC VR-2072, Strain A/Washington/897/80xA/Mallard/New york/6750/78) at 5 minutes, room temperature (20° C.) with 5% fetal bovine serum organic soil. These two lots evaluated against carriers with carrier counts of 5.5 logs showed PASSED with complete inactivation with greater than or equal to 4.5 log reductions. Two lots of this formulation were evaluated in an independent laboratory per US EPA approved methods by a germicidal spray test for a virucide for Herpes simplex virus Type 1, ATCC VR-733, Strain F(1) at 5 minutes, room temperature (20° C.) with 5% fetal bovine serum organic soil. These two lots evaluated against carriers with carrier counts of 5.5 logs showed PASSED with complete inactivation with greater than or equal to 5.0 log reductions. Two lots of this formulation were evaluated in an independent laboratory per US EPA approved methods by a germicidal spray test for a virucide for Herpes simplex virus Type 2, ATCC VR-734, Strain G at 5 minutes, room temperature (20° C.) with 5% fetal bovine serum organic soil. These two lots evaluated against carriers with carrier counts of 4.75 logs showed PASSED with complete inactivation with greater than or equal to 4.25 log reductions.

Additional testing was carried out on formulation lots 2 and 3 at a PCMX concentration of 0.18% each for the “Big 3”. These formulations which were over 2 years old were evaluated in an independent laboratory in a GLP study per the AOAC Germicidal Spray Method. The organisms Staphylococcus aureus (ATCC 6538), Pseudomonas aeruginosa (ATCC 15442), and Salmonella enterica (ATCC 10708) were assessed at 9 minutes and 45 seconds at room temperature (21-22° C.) with 5% fetal bovine serum organic soil. The carrier counts were: Staphylococcus aureus=3.16×10⁶ CFU/carrier (6.50 logs), Pseudomonas aeruginosa=1.15×10⁶ CFU/carrier (6.04 logs), and Salmonella enterica=1.23×104 CFU/carrier (4.41 logs). For lot #2 Staphylococcus aureus=0/60 subculture tubes demonstrated growth of the test organism PASSED), Pseudomonas aeruginosa=0/60 subculture tubes demonstrated growth of the test organism (PASSED), Salmonella enterica=0/60 subculture tubes demonstrated growth of the test organism (PASSED). For lot #3 Staphylococcus aureus=0/60 subculture tubes demonstrated growth of the test organism (PASSED), Pseudomonas aeruginosa=0/60 subculture tubes demonstrated growth of the test organism (PASSED), Salmonella enterica=0/60 subculture tubes demonstrated growth of the test organism (PASSED).

### Example 77

Left blank intentionally

### Example 78

Left blank intentionally

### Example 79

Left blank intentionally

### Example 80

### 03242011, T70

A concentrate composition was made with 28.3% sodium laureth sulfate, 9.5% decyl glucoside, 10.24% PCMX, 30.0% propylene glycol with no added deionized water. Without pH adjustment the pH was about 8.5-9.

Prepared a Ready-to-Use solution by adding 2.5 ml of the concentrate to 100 ml of deionized water (about a 2500 ppm PCMX concentration) the solution was crystal clear with no ppt., nor oil. Refrigerated through 101 days solution remained crystal clear.

### Example 81

### 110910, MC1084

A concentrate composition was made with 30.0% sodium laureth sulfate, 10% glucoside, 10.25% PCMX, 10.9% terpineol, 15.7% propylene glycol with no added deionized water. Without pH adjustment the pH was about 10. With pH adjustment with concentrated HCl the pH was 8.55

In an independent laboratory, microbiological testing was conducted with the formulation at about 200 ppm PCMX in deionized water and 2.5% sodium chloride solutions at room temperature (23±2° C.). The organisms studied were Bacillus cereus ATCC#14579, Pseudomonas fluorescens ATCC#13525, and Aspergillus niger spores ATCC#9642. The contact times for testing were less than one minute, 1 and 3 hours. For the vegetative bacteria Bacillus cerus and Pseudomonas fluorescens at all times and for both organisms the number of organisms remaining were <1 organism (no growth). The log reductions were greater than 4 logs demonstrating significant antibacterial activity. For the A. niger spores tested with deionized water and 2.5% sodium chloride the reductions were 58.75% and 77.78% at 3 hours respectively.

Prepared a Ready-to-Use solution by adding 2.5 ml of the concentrate (MC 1084) to 100 ml of deionized water (about a 2500 ppm PCMX concentration) the solution was crystal clear with no ppt., nor oil. Refrigerated through 101 days solution remained crystal clear.

In the foregoing description, certain terms have been used for brevity, clarity and understanding, however, no unnecessary limitations are to be implied therefrom, because such terms are used for descriptive purposes and are intended to be broadly construed. Moreover, the descriptions and examples herein are by way of examples and the exemplary embodiment is not limited to the exact details shown and described.

In the following claims, any feature described as a means for performing a function shall be construed as encompassing any means known to those skilled in the art to be capable of performing the recited function, and shall not be limited to the features and structures shown herein or mere equivalents thereof. The description of the exemplary embodiment included in the Abstract included herewith shall not be deemed to limit the invention to features described therein.

Having described the features, discoveries and principles of the invention, the manner in which it is formulated and operated, and the advantages and useful results attained; the new and useful compositions, ingredients, combinations, systems, operations, methods and relationships are set forth in the appended claims.

1. A ready to use emulsion composition for disinfecting, sanitizing, and cleaning surfaces, said composition comprising:
(a) water;
(b) at least one hydrophobic antimicrobial agent selected from the group consisting of (i) a halogen substituted xylenol compound, (ii) a phenolic compound, (iii) an antimicrobial natural or essential oil, (iv) an antimicrobial component from natural or essential oil, and (v) combinations of at least two of (i), (ii), (iii), and (iv);
(c) at least one surfactant, wherein said surfactant is selected from the group consisting of anionic surfactant, amphoteric surfactant, nonionic surfactant, and blends thereof;
(d) at least one solubilizing agent; and
(e) optionally at least one metal chelator; and
(f) optionally at least one thickening agent.

2. The biocide composition of claim 1, wherein said antimicrobial agent in (b) is a halogen substituted xylenol.

3. The composition of claim 2, wherein said halogen substituted xylenol is parachlorometaxylenol.

4. The composition of claim 3, wherein said surfactant is selected from the group consisting of alkyl sulfates, alkyl ether sulfate, potassium ricinoleate, alkyl glucosides, and mixtures thereof.

5. The composition of claim 4, wherein said surfactant is a mixture of potassium ricinoleate and sodium dodecyl sulfate.

6. The composition of claim 3, wherein said solubilizing agent is selected from the group consisting of low molecular weight alcohols having from 2 to 10 carbon atoms, glycols, terpineols, phenoxetol, and mixtures thereof.

7. The composition of claim 6, wherein said low molecular weight alcohol is isopropyl alcohol.

8. The composition of claim 6, wherein said solubilizing agent is a mixture of terpineol, phenoxteol, and isopropyl alcohol.

9. The composition of claim 1, wherein said thickening agent is present and is selected from the group consisting of sodium chloride, acrylic polymers, carbomers, polysaccharides, vegetable gums, proteins, and polyethylene glycol.

10. The composition of claim 1, wherein said water is deionized water.

11. The composition of claim 1, wherein said antimicrobial agent is present at a level of from about 0.18 to about 0.28 weight percent.

12. The composition of claim 11, wherein said antimicrobial agent is present at a level of from about 0.20 to about 0.24 weight percent.

13. The composition of claim 1, wherein said surfactant is present at a level of from about 0.1 to about 0.8 weight percent.

14. The composition of claim 13, wherein said surfactant is present at a level of from about 0.25 to about 0.45 weight percent.

15. The composition of claim 1, wherein said solubilizing agent is present at a level of from about 0.2 to about 1.0 weight percent.

16. The composition of claim 17, wherein said solubilizing agent is present at a level of from about 0.65 to about 0.85 weight percent.

17. The composition of claim 1 comprising:
(a) From about 97.78 to about 98.87 weight percent water;
(b) From about 0.2 to about 0.24 weight percent parachlorometaxylenol;
(c) From about 0.2 to about 0.4 weight percent potassium ricinoleate;
(d) From about 0.06 to about 0.1 weight percent sodium dodecyl sulfate;
(e) From about 0.2 to about 0.4 weight percent terpineol; and
(f) From about 0.03 to about 0.1 weight percent sodium polyphosphate;
(g) From about 0.3 to about 0.6 weight percent isopropyl alcohol;
(h) From about 0.04 to about 0.08 weight percent phenoxetol; and
(i) From about 0.1 to about 0.3 weight percent trisodium ethylene diamine tetraacetic acid.

18. The composition of claim 1 in the form of a thickened gel.

19. The composition of claim 1, wherein said at least one metal chelator is selected from the group consisting of trisodium ethylene diamine tetraacetic acid, sodium polyphosphate, and mixtures thereof.

20. The composition of claim 19, wherein said metal chelator is present at a level of from about 0.15 to about 0.4 weight percent.

21. The composition of claim 1 having a particle size of less than about 100 nm and a zeta potential number greater than about −60 mv.

22. A process for producing a ready to use emulsion composition for disinfecting, sanitizing, and cleaning surfaces comprising:
(I) mixing together to form an emulsion the following ingredients:
(a) water;
(b) at least one hydrophobic antimicrobial agent selected from the group consisting of (i) a halogen substituted xylenol compound, (ii) a phenolic compound, (iii) an antimicrobial natural or essential oil, (iv) an antimicrobial component from natural or essential oil, and (v) combinations of at least two of (i), (ii), (iii) and (iv);
(c) at least one surfactant, wherein said surfactant is selected from the group consisting of anionic surfactant, amphoteric surfactant, nonionic surfactant, and blends thereof;
(d) at least one solubilizing agent;
(e) optionally at least one metal chelator; and
(f) optionally at least one thickening agent.
(II) testing the pH and, if necessary, adjusting the pH of the emulsion to between 6 to 9 pH.
(III) optionally filtering said composition with a submicron filter; and
(IV) Packaging said composition in a suitable container.

23. The process of claim 22, wherein said antimicrobial agent is parachlorometaxylenol.

24. The process of claim 22, wherein said water is deionized water.

25. The process of claim 22, wherein said surfactant is a mixture of potassium ricinoleate and sodium dodecyl sulfate.

26. The process of claim 22, wherein said solubilizing agent is a mixture of terpineol, phenoxetol, and isopropyl alcohol.

27. The process of claim 23, wherein said parachlorometaxylenol is present at a level of from about 0.2 to about 0.24 weight percent.

28. The process of claim 25, wherein said surfactant mixture is present at a level of from about 0.26 to about 0.5 weight percent.

29. The process of claim 26, wherein said solubilizing agent mixture is present at a level of from about 0.54 to about 1.08 weight percent.

30. The process of claim 22, wherein said metal chelator is selected from the group consisting of trisodium ethylene diamine tetraacetic acid, sodium polyphosphate, nitrilotriacetic acid, and mixtures thereof.
